(19) United States
(12) Patent Application Publication
(10) Pub. No.: US 2020/0310473 A1
(43) Pub. Date: Oct. 1, 2020

(54) THERMOSTATIC CARTRIDGE FOR REGULATING COLD AND HOT FLUIDS TO BE MIXED

(71) Applicant: VERNET, OLLAINVILLE (FR)

(72) Inventors: Axel BELAIR, BRUYERES-LE-CHÂTEL (FR); Cédric MOLLARD, ARPAJON (FR)

(21) Appl. No.: 16/754,724

(22) PCT Filed: Oct. 8, 2018
(86) PCT No.: PCT/EP2018/077345

§ 371 Date: Apr. 8, 2020

(30) Foreign Application Priority Data
Oct. 9, 2017 (FR) 1759419

(51) Int. Cl. G05D 23/13; F16K 11/06; F16K 11/16

(52) U.S. Cl. CPC G05D 23/1353; F16K 11/161; F16K 11/06

(57) ABSTRACT

A cartridge has a base, a slide, a thermostatic actuator, a cover, and a regulation and control system. A mixing chamber has base in an assembled state has two superimposed base parts which, in an assembled state, are superimposed one against the other along an axis with an interpositioned seal. The slide is movable in the chamber to inversely vary the flow sections of two passages, supplied through the two base parts and delimited axially between the slide and the two base parts. The thermostatic actuator in the chamber moves the slide to a regulation position as a function of the temperature of the mixture exiting the chamber. The cover is secured to the base in the assembled cartridge.

### PRIORITY AND CROSS REFERENCE TO RELATED APPLICATIONS

This application is the U.S. National Phase Application under 35 U.S.C. § 371 of International Application No. PCT/EP2018/077345, filed Oct. 8, 2018, designating the U.S. and published in English as WO 2019/072772 A1 on Apr. 18, 2019, which claims the benefit of French Application No. FR 1759419, filed Oct. 9, 2017. Any and all applications for which a foreign or a domestic priority is claimed is/are identified in the Application Data Sheet filed herewith and is/are hereby incorporated by reference in their entireties under 37 C.F.R. § 1.57.

### FIELD

The present invention relates to a thermostatic cartridge.

### SUMMARY

The present invention relates to a thermostatic cartridge for regulating cold and hot fluids to be mixed.

### BRIEF DESCRIPTION OF THE DRAWINGS

The invention will be better understood upon reading the description which follows, given solely by way of example and with reference to the drawings, wherein:

FIG. 1 shows an exploded perspective of a thermostatic assembly;

FIG. 2 shows an exploded perspective of a thermostatic cartridge according to the invention, comprising the assembly of FIG. 1 where it is shown assembled;

FIGS. 3 and 4 show elevational views respectively according to the arrows III and IV of FIG. 1 which show the assembly being assembled;

FIG. 5 shows an elevational view along the arrow V of FIG. 3;

FIGS. 6 and 7 show sections respectively along the lines VI-VI and VII-VII of FIG. 5, which show the assembly in the assembled state;

FIG. 8 shows a section in the same plane as that of FIG. 6, showing the thermostatic cartridge of FIG. 2 during assembly; and

FIG. 9 shows a view similar to FIG. 8 showing the thermostatic cartridge in the assembled state.

### DETAILED DESCRIPTION

In the sanitary field, a cartridge is a device for regulating hot and cold fluids to be mixed, in particular hot and cold water.

The cartridge is qualified as thermostatic when it incorporates a thermostatic actuator, in particular a thermostatic element associated with a return spring, which comprises a first part, normally fixed relative to a hollow base of the cartridge, and a second part that is movable with respect to the axis of the base relative to the first part under the effect of heat applied to the actuator, for example under the action of the expansion of a thermally-expandable material contained within the thermostatic element. The second part of the thermostatic actuator is secured to an axially displaceable slide inside the base of the cartridge, in order to inversely vary the sections of the flow passages in the base for the hot and cold fluids in order to mix these two fluids in variable proportions and to obtain, downstream of the slide, a fluid, called the mixture, or mixed fluid or mitigated fluid, flowing along a thermosensitive region of the thermostatic actuator and exiting the base. By modifying the position of the first part of the thermostatic actuator relative to the base by means of an ad hoc setpoint mechanism, the setpoint temperature is varied and around which the temperature of the mixture is thus regulated by the slide.

Furthermore, in order to vary the flow rate of cold fluid and the flow rate of hot fluid sent to the slide via the base, the cartridge incorporates a regulating member, such as a set of ceramic discs which are so mounted as to be at least partially movable in a housing fixed to the base. This regulating member and the above-mentioned setpoint mechanism makes it possible to modify the position of the thermostatic actuator with respect to the base, wherein they together form a regulation and control system which makes it possible to simultaneously vary the flow rates of the respective cold fluid and hot fluid supplying the slide and to regulate the flow and temperature of the mixture exiting the cartridge. As detailed in WO 2017/137368, this regulation and control system may be divided into several types depending on how the flow rate and the temperature of the mixture are regulated: thus, the thermostatic cartridge may be, for example of the single-control type, of the double-control type, or of the sequential type.

In all cases, as explained in WO 2017/005860 and as indicated in WO 2017/137368, it may be advantageous if the base is not in one piece, but is made in two distinct parts, which are assembled by being axially superimposed one against the other, while providing a seal for their junction interface. One possibility for sealing this junction interface is to interpose a seal comprising one or more seals axially between the two parts of the base. In practice, the presence of this seal tends to cause the two parts of the base to move apart axially from one another, with the risk of disassembly of the two parts of the base as long as the cartridge is not mounted and fixed inside a mixing valve. Likewise, as long as the cartridge is not mounted and fixed inside a mixing valve, the thermostatic actuator may exert constraints that tend to separate the two parts of the base axially from one another: thus, when this actuator comprises a thermostatic element associated with a return spring, the latter is interposed between the thermostatic element and one of the two parts of the base, wherein one of the ends of the return spring rests axially against one part of the base, while the other end of the return spring flattens the slide axially against the other part of the base.

To address this problem, the attachment between the two parts of the base may be rigid, for example by using welds or glue between the two parts of the base. These solutions are effective but tend to increase the total assembly time and, by nature, they prohibit any disassembly of the base, thus preventing the recovery, if necessary, of the two parts of base, as well as the slide and the thermostatic actuator retained between the two parts of the base.

The object of the present invention is to provide a thermostatic cartridge whose base, although made in two parts, is fast and convenient to assemble.

For this purpose, the invention relates to a thermostatic cartridge for regulating cold and hot fluids that are to be mixed, wherein the thermostatic cartridge comprises:
a base, which defines an axis and which comprises two separate base parts that are designed to be assembled to one another in an assembled state of the thermostatic cartridge, wherein in an assembled state of the first and second base parts, the two base parts are superimposed axially against each other, with the interposition of a seal, and together delimit a chamber for mixing cold and hot fluids, wherein the chamber is sealed by the seal while being connected to the outside of the base both by a first inlet for the cold fluid and a second inlet for the hot fluid which are delimited by one of the two base parts, and by an outlet for a mixture of the cold and hot fluids, which is delimited by the other of the two base parts,
a slide, which is displaceable substantially parallel to the axis inside the chamber in order to inversely vary the respective flow sections of a first passage, which is supplied by the first inlet and which is delimited axially between the slide and one of the two base parts, and a second passage, which is supplied by the second inlet and which is delimited axially between the slide and the other of the two base parts,
a thermostatic actuator, which is at least partially arranged in the chamber and which is connected to the slide and the base in order, as a function of the temperature of the mixture, to move the slide inside the chamber to a regulation position corresponding to a set temperature which is defined by the axial position that has a dedicated part of the thermostatic actuator,
a cover which, in the assembled state of the thermostatic cartridge, is secured to the base, and
a regulation and control system, which is at least partially movably mounted in the cover so as, in the assembled state of the thermostatic cartridge, both to vary the flow rate of the cold fluid supplied to the first inlet and the flow rate of the hot fluid supplied to the second inlet, and to regulate the flow and temperature of the mixture in the outlet.

A first of the two base parts comprises at least one tab:
which extends substantially parallel to the axis,
which, at a first end of its two axial ends, is connected to the rest of the first base part both fixedly along the axis and deformably to allow an elastic deflection of the at least one tab transversely to the axis,
which, at its second axial end, is provided with at least one retaining surface against which the second base part bears axially in order to hold the first and second base parts assembled, and
which, at its second axial end, is also provided with a protruding relief which is designed to interact with the cover, so that, during assembly of the cover and the base, the cover and the protruding relief slide against one another to deflect the tab towards the axis and, in the assembled state of the thermostatic cartridge, the protruding relief engages a hole of the cover to axially retain the cover relative to the base.

One of the ideas underlying the invention is to provide for a first one of the two parts of the base to have one or more tabs that are designed to snap onto the second part of the base. According to the invention, each tab is elongated substantially parallel to the axis of the base and is designed to deflect transversely to the axis during assembly of the two parts of the base by means of the elastic deformation of the axial end of each tab connecting the latter to the rest of the first part of the base. The snap on effect is obtained by one or more retaining surfaces which are provided at the opposite end of each tab: as soon as the two parts of the base are assembled to one another, the retaining surface(s) form(s) axial stops for the second part of the base which can not be released axially from the first part of the base. The use of the tab(s) significantly limits the time required to assemble the two parts of the base, while ensuring reliable retention of the two assembled parts of the base. In addition, the reversibility of the elastic deflection of the tabs may be used to allow the dismountability of the two parts of the base, provided that the appropriate constraints are applied to the tab(s) to release the retaining surfaces from their axial interference with the second part of the base. It is to be understood that the base, the slide and the thermostatic actuator belonging to the cartridge according to the invention may, in the assembled state of the two parts of the base, advantageously form a removable preassembled module, which may be disassembled if necessary, for example in the event of failure of this module and which, otherwise, are ready to be assembled to the cover and the regulation and control system in order to manufacture a functional thermostatic cartridge, which may then be assembled and fixed in a mixing valve. The aforesaid module may thus be manufactured and stored independently of the rest of the thermostatic cartridge, wherein it is integrated later. Moreover, according to the invention, the deflection capacity of the, or each, tab of the cartridge according to the invention is used to facilitate the assembly of this thermostatic cartridge, by involving the tab(s) in the attachment of the cover to the base.

According to additional advantageous features of the cartridge according to the invention:
The at least one tab extends from a peripheral portion of the first base part and interacts with a peripheral portion of the second base part so that, during assembly of the first and second base parts, the peripheral portion of the second base part and the at least one tab slide against each other in order to deflect the at least one tab in opposite direction to the axis and, in the assembled state of the first and second base parts, the at least one retaining surface engages the peripheral portion of the second base part in order to axially retain the first base part relative to the second base part.
The at least one retaining surface of the at least one tab protrudes from a side edge of the at least one tab.
The at least one retaining surface of the at least one tab protrudes from a side edge of the at least one tab in a direction that is orthoradial to the axis.
The at least one tab is provided with two retaining surfaces which extend on either side of the at least one tab, respectively from either of the side edges of the at least one tab.
The first base part is provided with at least two tabs which are distributed around the axis.
The first base part is provided with two tabs which are diametrically opposite relative to the axis and which have respective widths that are different from each other.
The second base part comprises, for the at least one tab, a housing, which is designed to receive the at least one tab in the assembled state of the first and second base parts, and within which the second base part defines, for the at least one retaining surface, a bearing surface against which the at least one retaining surface abuts axially to hold the first and second base parts assembled.
The thermostatic actuator comprises:
   a thermostatic element which comprises a body, containing a thermally-expandable material, and a piston that is displaceable in translation substantially along the axis relative to the body under the effect of expansion of the thermally-expandable material, wherein the piston forms said dedicated part of the thermostatic actuator, and wherein the body is connected to the slide to move the slide in substantially axis-wise translation within the chamber, and
   a return spring which is axially interposed between the body of the thermostatic element and one of the first and second base parts in order to return the body and the piston to one another during contraction of the thermally-expandable material.
The base, the slide and the thermostatic actuator together form, in the assembled state of the first and second base parts, a demountable preassembled module.
The cover and the protruding relief are provided to slide against one another in order to deflect the at least one tab towards the axis during an axial connection between the base and the cover.

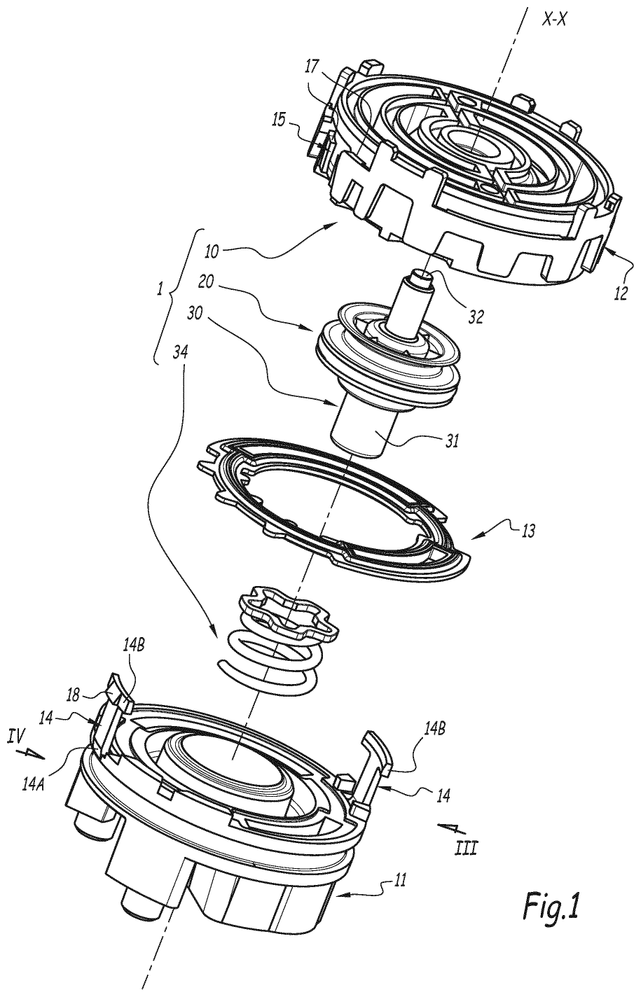

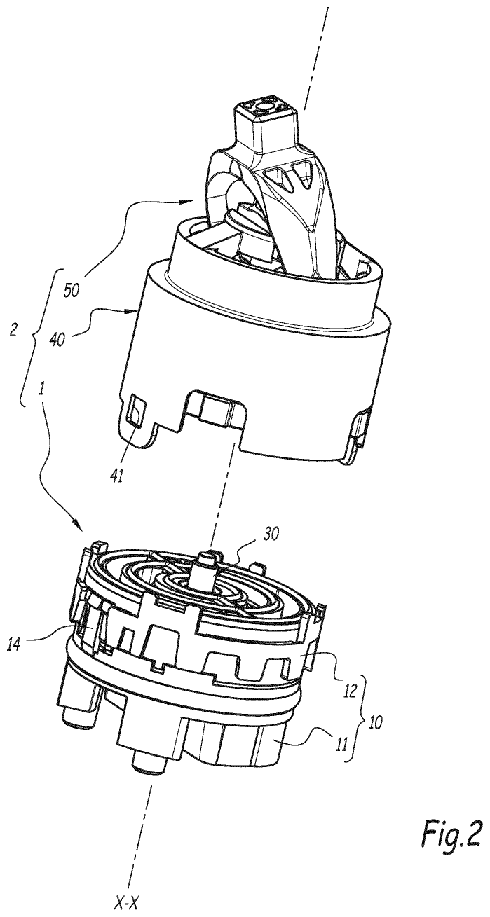

FIGS. 1 and 3 to 7 show only one assembly 1 which belongs to a thermostatic cartridge 2 shown as a whole in FIGS. 2, 8 and 9. The thermostatic cartridge 2 is designed to equip a mixing valve, not shown as such in the figures, and intended to be supplied with hot and cold water. More generally, the thermostatic cartridge 2 is designed to equip a sanitary installation delivering a fluid that is obtained by mixing a hot fluid and a cold fluid in the cartridge.

The assembly 1 is centered on a geometric axis X-X. For convenience, the following description is oriented relative to this axis X-X, wherein it is considered that the terms “upper”, “top” and the like correspond to an axial direction facing the upper part of FIGS. 1 to 4 and 6 to 9, while the terms “lower”, “low” and the like correspond to an axial direction in the opposite direction. Thus, within the thermostatic cartridge 2, the assembly 1 is arranged in the lower part of the thermostatic cartridge.

As may be clearly seen in FIGS. 1 to 7, the assembly 1 comprises a base 10 having a generally cylindrical outer shape, centered on the axis X-X. The base 10 comprises two distinct base parts, which, in the assembled state of the assembly 1, are arranged one above the other along the axis X-X, wherein these parts of the base therefore correspond to a lower part 11 and an upper part 12. In the assembled state of the assembly 1, the parts 11 and 12 are axially superimposed one on the other, and are assembled to one another as detailed below to form a junction interface between them that extends transversely to the axis X-X.

The junction interface between the low 11 and high 12 parts is sealed in the sense that the areas of material contact between these parts 11 and 12 are sealed, thus prohibiting the passage of fluid through these contact areas. To do this, a seal 13 is attached to the junction interface by being interposed axially between the low 11 and high 12 parts. In practice, this seal 13 comprises or consists of one or more seals which, in the assembled state of the base 10, are enclosed axially between the parts 11 and 12. This being the case, the embodiment of the seal 13 is not limiting.

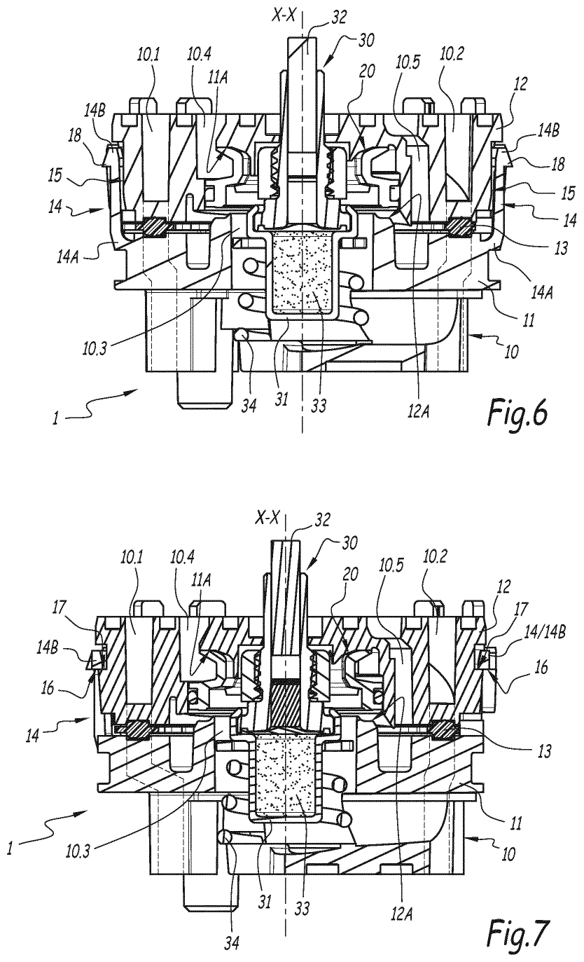

As shown in FIG. 2 and as clearly visible in FIGS. 6 and 7, the base 10 is provided with a channel 10.1 for circulating cold water between the lower face and the upper face of the base 10: this channel 10.1 is delimited successively by the lower part 11 and the upper part 12 and passes through the junction interface between these parts 11 and 12, wherein it is sealed at this interface by the seal 13. Similarly, the base 10 is provided with a channel 10.2 for circulating hot water between the lower face and the upper face of the base: wherein this channel 10.2 is delimited successively by the lower part 11 and the upper part 12 and passes through the junction interface between these parts 11 and 12 and is sealed therein by the seal 13.

As is clearly visible in FIGS. 6 and 7, the base 10 encloses a chamber 10.3 which is traversed by the axis X-X and which, in the exemplary embodiment considered in the figures, is centered on this axis. The chamber 10.3 consists of internal free volumes respectively delimited by the lower part 11 and the upper part 12 of the base 10, wherein the chamber 10.3 extends axially on either side of the junction interface between these parts 11 and 12 by being sealed at this interface by the seal 13.

Separately from the chamber 10.3, the base 10 is provided with a cold water inlet 10.4 and a hot water inlet 10.5, which, in the embodiment considered in the figures, are located transversely to the axis X-X on either side of the chamber 10.3. The cold water inlet 10.4 and the hot water inlet 10.5 each open at their upper end on the upper face of the base 10, while at their lower end these inlets 10.4 and 10.5 each open into the chamber 10.3, wherein the lower end of the inlet 10.4 is located axially higher than that of the inlet 10.5 as shown in FIGS. 6 and 7. The inlets 10.4 and 10.5 thus connect the chamber 10.3 outside the base 10, more specifically at the upper face of this base. The inlets 10.4 and 10.5 are thus delimited at least partially by the upper part 12 of the base 10: in the exemplary embodiment considered in the figures, the cold water inlet 10.4 is delimited exclusively by the upper part 12 of the base 10 while the hot water inlet 10.5 is delimited by both the upper part 12 traversing the latter axially from one side, and the lower part 11 of the base 10 extending only to an upper region of this lower part 11.

The base 10 is also provided with a mixing outlet 10.6, which, at its upper end, opens into the chamber 10.3 while at its lower end this outlet 10.6 opens onto the lower face of the base 10. The outlet 10.6 thus connects the chamber 10.3 to the outside of the base 10, more specifically to the underside of the latter. The outlet 10.6 is thus delimited at least partially by the lower part 11 of the base 10: in the embodiment considered in the figures, this outlet 10.6 is delimited exclusively by the lower part 11 by being substantially centered on the X-X axis as is clearly visible in FIGS. 6 and 7.

In use, particularly when the thermostatic cartridge 2 is received and fixed in a mixing valve or the like, the circulation channels 10.1 and 10.2 are designed to be supplied respectively with cold water and hot water from the bottom face of the base 10. After leaving the base 10 by its upper face, this cold water and hot water circulate inside the rest of the thermostatic cartridge 2 where they are returned to the upper face of the base 10 in order to supply the inlets 10.4 and 10.5 respectively. This cold water and this hot water, flowing downwards respectively in the inlets 10.4 and 10.5, then supply the chamber 10.6 in which they mix to form a mixed water, hereinafter referred to as a mixture, which exits the chamber 10.3 by the outlet 10.6 and is evacuated downwards.

The assembly 1 also includes a slide 20 which, as may be clearly seen in FIGS. 1, 6 and 7, has a generally tubular shape, centered on an axis which, in the assembled state of the assembly 1, is parallel or even coincides with the X-X axis.

The slide 20 is mounted on the base 10, more specifically inside the chamber 10.3 of this base, and movable parallel to the X-X axis between two extreme positions, i.e.:
an extreme low position, in which the lower face of the slide 20 bears against a low seat 11A, which is delimited by the lower part 11 of the base 10 and which is thus fixed with respect to this base, and
an extreme high position, wherein the upper face of the slide 20 is abuts against a high seat 12A, which is defined by the upper part 12 of the base 10 and which is thus fixed relative to this base.

The total axial dimension of the slide 20 that respectively separates its upper and lower faces from each other, is smaller than the axial distance separating the lower seat 11A and the upper seat 12A from each other. Also, when the slide 20 is in its extreme high position, as is the case in FIGS. 6 and 7, the slide 20 closes a cold water inlet inside the chamber 10.3 through axial bearing of the slide against the high seat 12A, while opening a hot water passage as far as possible, which is defined axially between the slide and the low seat 11A and which allows the hot water from the inlet 10.5 to flow into the chamber 10.3. Conversely, when the slide is in its extreme low position, the slide closes a hot water inlet inside the chamber 10.3 through axial bearing of the slide against the low seat 11A, while opening a cold water passage as far as possible, which is delimited axially between the slide and the upper seat 12A and which feeds the cold water from the inlet 10.4 into the chamber 10.3. In use, the hot water passage is supplied with hot water through the inlet 10.5 while the cold water passage is supplied with cold water through the inlet 10.4: according to the axial position of the slide 20 between its extreme high and low positions, the respective flow sections of the cold water passage and the hot water passage vary inversely, i.e. the amounts of cold water and hot water admitted in the chamber 10.3 are regulated in respective inverse proportions according to the axial position of the slide 20. In FIGS. 6 and 7, the slide 20 is in the extreme high position for reasons that will be given later.

In practice and to ensure the guiding of the movable assembly of the slide 20 in the chamber 10.3, the lateral face of this slide is received inside a complementary surface of the chamber 10.3 in a tightly sealed manner through the interposition of a seal to prevent mixing between the cold water and the hot water upstream of the slide. In addition, in order that the cold water admitted into the chamber 10.3 from the inlet 10.4 may join and mix with the hot water admitted inside this chamber from the inlet 10.5 to thus form the aforementioned mixture flowing downstream of the slide to the outlet 10.6, the slide 20 delimits internally one or more flow passages which connect its upper and lower faces to each other, some of which are visible in the FIGS. 1 and 6. The embodiment of the arrangements described in this paragraph is not limiting.

To drive the slide 20 in axial displacement and thus to control its axial position, the assembly 1 also comprises a thermostatic element 30 comprising a body 31 and a piston 32. The body 31 contains a thermally-expandable material 33 which, by expansion, causes displacement relative to the translation of the piston 32. The body 31 and the piston 32 are centered on the corresponding translation axis, wherein this translation axis is parallel to, or even coincident with, the axis X-X in the assembled state of the assembly 1. Likewise in the assembled state of the assembly 1, the body 31 is connected to the slide 20 in order to move the slide between its extreme high and low positions in translation substantially along the axis X-X: in the embodiment shown in the figures, the body 31 is secured to the slide 120 by any suitable means. In any event, at least a portion of the body 31 is arranged in the chamber 10.3 so that the thermally-expandable material 33 may be sensitized by the heat of the mixture flowing downstream of the slide 20 along the body 31.

The thermostatic element 30 is also associated with a return spring 34, typically a compression spring, which acts on the body 31 of the thermostatic element 30, and thus on the slide 20 connected to this body 31 but in an opposite manner to the deployment of the piston 32 out of the body 31 resulting from an expansion of the thermally expandable material 33. The return spring 34 is axially interposed between the base 10 and the slide 20 so that, during the contraction of the thermally expandable material 33, this return spring partially relaxes and allows the piston 32 to return inside the body 31. In the embodiment considered here, the return spring 34 is axially interposed between the lower part 11 of the base 10 and the body 31 of the thermostatic element.

As indicated above, the assembly 1 belongs to the thermostatic cartridge 2 and, as such, is intended to be assembled with the other components of this thermostatic cartridge 2. According to a particularly advantageous embodiment, which is illustrated in the figures, the assembly 1 forms a self-contained module, which is preassembled independently of the other components of the thermostatic cartridge 2. For this purpose, the lower 11 and high 12 parts of the base have fixtures for assembling them to each other in the presence of the seal 13, the slide 20, the thermostatic element 30 and the return spring 34, as shown in FIGS. 6 and 7, as well as in the lower half of FIG. 2. These arrangements will now be described in more detail below.

For the purpose of assembling the base parts 11 and 12 with each other, the lower base part 11 comprises two tabs 14 while the upper base part 12 comprises two housings 15 which, in the assembled state of the two parts of the base, respectively receive the tabs 14.

As clearly visible in FIGS. 1, 3, 4, 6 and 7, each tab 14 has an elongated shape, extending in length substantially parallel to the axis X-X. Each tab 14 thus has a lower end 14A which connects the tab 14 to the rest of the base part 11. In the embodiment shown in the figures, the tab 14 is thus integral with the rest of the base part 11. In all cases, the lower end 14A of each tab 14 simultaneously connects the tab 14 to the rest of the base part 11 in a fixed manner along the axis X-X and in a deformable manner to allow elastic deflection of the tab 14 transversely to the axis X-X. In other words, each tab 14 is designed to deflect in a direction transverse to the axis X-X, by means of the elastic deformation of at least its lower end 14A relative to the rest of the base part 11, without modifying the axial position of this lower end 14A with respect to the rest of the base part 11.

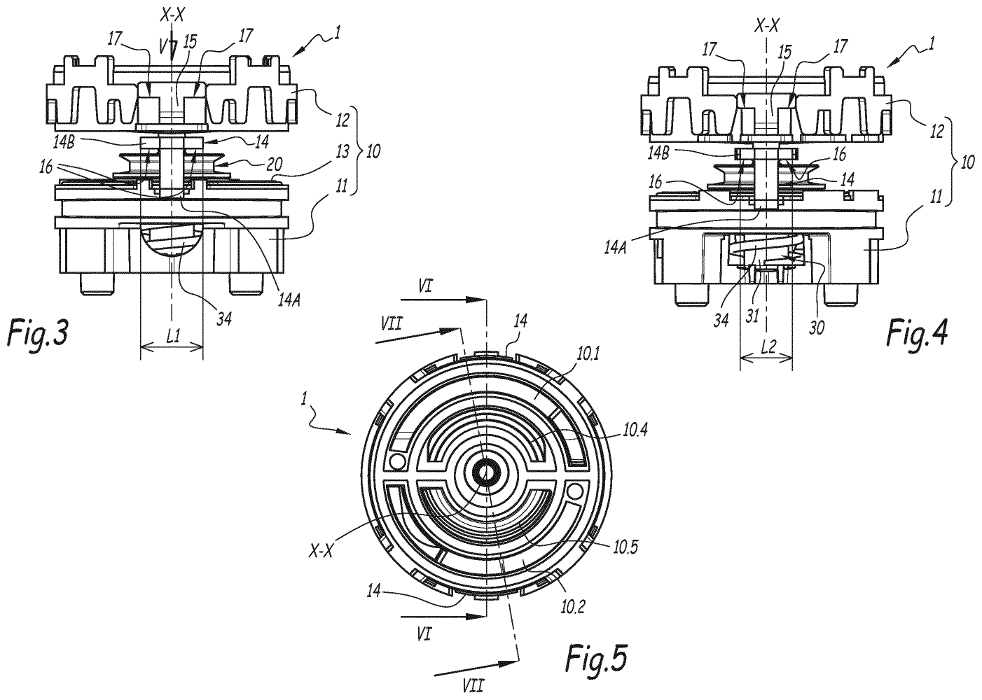

Opposite its lower end 14A, each tab 14 has a high end 14B which is shaped to snap onto the base part 12, in particular inside the housings 15 of the latter in the assembled state of the two base parts 11 and 12. For this purpose, the upper end 14B of each tab 14 protrudes on both lateral sides of the tab, conferring on the latter an overall “T” shape as is clearly visible in FIGS. 1, 3 and 4. More specifically, at the high end 14B of each tab 14, the tab is provided with two retaining surfaces 16, which project from, respectively, each of the side edges of the tab, thus being located on either side in a direction that is orthoradial to the axis X-X of the tab 14. In the embodiment shown in the figures, each of the four retaining surfaces 16 protrude from the corresponding lateral edge of the associated tab 14 in a direction that is orthoradial to the X-X axis, in particular in a geometric plane that is perpendicular to this axis X-X. Likewise in the exemplary embodiment considered here, the aforementioned geometric planes, respectively associated with the four retaining surfaces 16, are merged, as may be seen in FIGS. 3 and 4, which is the equivalent of saying, more generally, that the four surfaces are located at the same level of the axis X-X. In all cases, in the assembled state of the two base parts 11 and 12, each of the retaining surfaces 16 is found to be in axial interference with the base part 12, more specifically is found in an axial view of a corresponding bearing surface 17, which is delimited by the base part 12 inside the housing 15 and associated with the tab 14 in question, as is clearly visible in FIG. 7. In other words, in the assembled state of the base parts 11 and 12, the latter are held together through axial abutment of the bearing surfaces 17 of the base part 12 against the retaining surfaces 16 of the tabs 14, more generally by axial bearing of the base part 12 against the retaining surfaces 16 of the tabs 14.

As soon as the base parts 11 and 12 are assembled together, as shown in FIGS. 6 and 7, it will be understood that the interference along the axis X-X between the retaining surfaces 16 of the tabs 14 and the base part 12 prevents axially separation of the base parts 11 and 12 from each other, since these two base parts are held axially relative to each other by the retaining surfaces 16 in a downward engagement with the bearing surfaces 17 in the housings 15. In order to allow the retaining surfaces 16 of the tabs 14 to thus be in engagement with the base part 12, the deflection capacity of the tabs 14 is used when assembling the two base parts 11 and 12, in order to allow the relative axial approach of these two base parts, wherein the tabs 14 are deflected in order to eliminate the interference with respect to the X-X axis between the retaining surfaces 16 and the base part 12 through elastic deformation of the tab; then, once the base parts 11 and 12 are sufficiently axially close to one another, the deformation of the tabs 14 is released so that the latter, by elastic return, come into engagement with the housings 15 and axially hold the two base parts 11 and 12 relative to each other.

In the extension of the immediately preceding considerations, a particularly advantageous arrangement is where the tabs 14 each extend from a peripheral portion of the base part 11 and where the housings 15 are each provided in a peripheral portion of the base part 12 as in the embodiment considered in the figures. In addition, upon assembling the base parts 11 and 12, more specifically during the axial approach of the base parts 11 and 12, the tabs 14 deflect outwards, i.e. in the direction opposite to the axis X-X, under the effect of the sliding of these tabs, more specifically their face facing the axis X-X, against the peripheral portions of the base part 12 where the housings 15 are located. In order to facilitate and guide the sliding contact between the tabs 14 and the aforementioned peripheral portions of the base part 12, suitable chamfers may advantageously be provided on the face of the tabs 14 facing the axis X-X, in particular at the upper ends 14B of the tabs, and/or on the outer face of the aforementioned peripheral portions of the base part 12, as are clearly visible in FIGS. 1, 6 and 7. Once the base parts 11 and 12 are sufficiently spaced apart axially from one another, the sliding contact between the tabs 14 and the aforementioned peripheral portions of the base part 12 ceases due to the introduction of the upper end 14B of each tab 14 into the interior of the housings 15 in order to engage the retaining surfaces 16 of the tabs 14 with the bearing surfaces 17 of the base part 12 as described above. It is to be understood that the assembly of the base parts 11 and 12 requires no dedicated tools to act directly on the tabs 14 to cause them to deflect. In particular, it is advantageously necessary to bring the base parts 11 and 12 closer to each other exclusively in a translation movement parallel to the axis X-X in order to assemble the base 10.

In practice, it will be noted that the assembly of the base parts 11 and 12 is implemented in the presence of the seal 13, the slide 20, the thermostatic element 30 and the return spring 34: wherein the presence of these elements, in particular of the seal 13 and the return spring 34, induces constraints which tend to axially separate the base parts 11 and 12 from one another. However, thanks to the interference along the axis X-X between the retaining surfaces 16 of the tabs 14 and the bearing surfaces 17 of the base part 12 once the base parts 11 and 12 are assembled, the aforementioned constraints are supported by the base 10 without the risk of disassembly of the latter. These constraints also explain why, in the assembled state of assembly 1, and as long as the thermostatic cartridge 2 with which this assembly 1 is integrated, is not received and fixed inside a mixing valve or the like, the slide 20 occupies its extreme high position described above while the retaining surfaces 16 of the tabs 14 press down the bearing surfaces 17 of the base part 12 axially, as shown in FIGS. 6 and 7.

It is also to be understood that the disassembly of the assembly 1 remains advantageously possible by means of the deflection of the tabs 14 towards the outside, provided that a suitable tool is used: this dismountability of the assembly 1 in the assembled state of the latter allows, for example in case of failure of this assembly, the recovery of all or part of its components.

In the exemplary embodiment considered in the figures, the two tabs 14 are diametrically opposite with respect to the axis X-X, which simultaneously promotes the alignment of the base parts 11 and 12 and the homogeneous distribution of the constraints applied to the tabs 14 in order to deflect them during assembly of the base parts 11 and 12. Advantageously, in order to undo the mounting of the base parts 11 and 12, the width, i.e. the dimension along a direction that is orthoradial to the axis X-X, is different for the two tabs: thus, at least on one axial portion of the tabs 14, in particular at their upper end 14B, the two tabs 14 have respective widths that are different from each other, as is clearly visible in FIGS. 3 and 4 in which the respective widths of the upper ends 14B of the tabs 14 are denoted L1 and L2.

Moreover, as shown in FIGS. 2, 8 and 9, the thermostatic cartridge 2 comprises, in addition to the assembly 1, a cover 40 inside which a regulation and control system 50 is mounted so as to be at least partially movable. In the assembled state of the thermostatic cartridge 2 as shown in FIG. 2, the cover 40 is secured to the base 10 of the assembly 1 and the regulation and control system 50 makes it simultaneously possible to vary the flow of cold water sent to the cold water inlet 10.4, to vary the flow of hot water sent to the hot water inlet 10.5, and to regulate the flow and temperature of the mixture in the outlet 10.6 of the assembly 1. The connection between the cover 40 and the base 10 have specificities which will be described later. As for the regulation and control system 50, its embodiment is not limiting and the reader may refer to WO 2017/137368 for examples of this regulation and control system 50, which, in particular, and according to the document, jointly or separately or successively control the flow rate and the temperature of the mixture leaving the thermostatic cartridge 2. In all cases, as also explained in WO 2017/137368, the regulation and control system 50 controls, in the assembled state of the thermostatic cartridge 2, the axial position of the piston 132, wherein this axial position defines a set temperature which is chosen by the user by acting on the regulation and control system 50 and which corresponds to a regulation position for the slide 20 inside the chamber 10.3 of the assembly 1, wherein this regulation position is controlled by the thermostatic element 30 and the return spring 34.

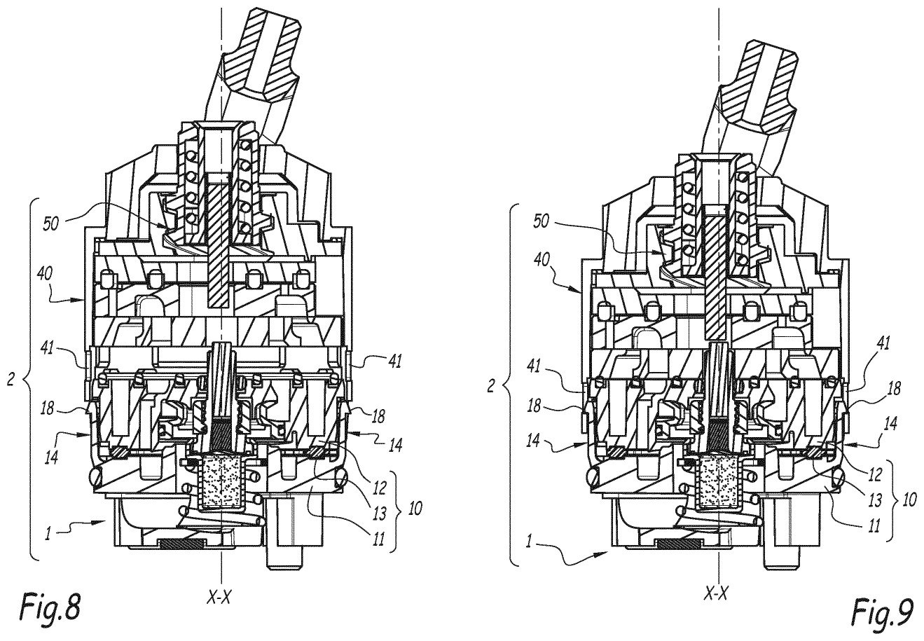

Furthermore, whatever the embodiment of the regulation and control system 50, the latter and the cover 40 advantageously form an autonomous module which, likewise as explained in detail in WO 2017/137368, is preassembled independently of the assembly 1 as shown in FIG. 2, before being assembled to this assembly 1 to manufacture the thermostatic cartridge 2, as shown in FIGS. 8 and 9.

In all cases, the tabs 14 participate in the fastening of the cover 40 to the base 10 while the deflection capacity of these tabs 14 is used to facilitate assembly between the cover 40 and the base 10. To this end, as clearly visible in FIGS. 1 and 6, each of the tabs 14 is provided at its upper end 14B, with a relief 18 which protrudes from the face of the tab facing away from the X-X axis. Each protruding relief 18 is designed to interact with the cover 40 so that:
during the assembly between the cover 40 and the base 10, in particular during an axial approach between the base 10 and the cover 40 as shown in FIG. 8, the relief 18 slides against the cover 40, in particular against the lower end of the latter in order to deflect the corresponding tab 14 inwards, i.e. towards the axis X-X, by means of the elastic deformation of the tab, in particular at its end 14A, as well as, where appropriate, the elastic deformation of the cover, in particular at its lower end, and
in the assembled state of the thermostatic cartridge 2 as shown in FIG. 9, each relief 18 engages in a hole 41, typically a through hole, of the cover 40 in order to axially retain the cover 40 with respect to the base 10 and avoid, in particular, axial spacing between them, wherein it is noted that the introduction of each relief 18 in the corresponding hole 41 advantageously results from the elastic return of the tab as soon as the constraint inducing its deflection is interrupted.

Thus, the respective reliefs 18 of the tabs 14 allow snapping the cover 10 onto the base part 11, wherein this snapping on is advantageously obtained exclusively by the relative axial approach of the cover 40 and the base 10. To facilitate and guide this snapping on, the relief 18 is advantageously chamfered appropriately.

Once the thermostatic cartridge 2 is assembled, it may be received and fixed inside a mixing valve or the like. In practice, this fixing is intended to induce an axial compression of the thermostatic cartridge so that the components of this thermostatic cartridge are placed under axial load inside the mixing valve to ensure their functional interaction. As soon as the thermostatic cartridge 2 is thus put under load, the retaining surfaces 16 can no longer be in contact with the bearing surfaces 17, just as the reliefs 18 can no longer bear axially downwards against the lower edge of the holes 41. It is thus understood that the tabs 14 do not have to be dimensioned to ensure their structural integrity for the entire lifetime of the thermostatic cartridge 2 since, once the thermostatic cartridge 2 is functional, the axial retention between the base parts 11 and 12 and the axial retention of the cover 40 with respect to the base 10 are provided essentially, or exclusively, by the fastening of the thermostatic cartridge 2 inside the mixing valve or the like.

Various arrangements and variants of the assembly 1 and the thermostatic cartridge 2 described so far are feasible. As examples:
rather than the tabs 14 belonging to the lower base part 1 and the housings 15 being delimited by the upper base part 12, the reverse may be provided;
the number of tabs 14 is not limited to two; in particular, only one tab may be provided while more than two tabs are feasible, wherein these tabs are then advantageously distributed, especially in a regular manner, about the axis X-X;
for each tab 14, only one retaining surface need be provided instead of the two retaining surfaces 16 envisaged above;
according to the conformation of the part of the base to which the tab(s) do not belong, this part of the base need not have a housing, in the strict sense of the term, such as the housing 15 envisaged above; and/or
within the assembly 1, rather than moving the slide 20 inside the chamber 10.3 by the thermostatic element 30 and the return spring 34, the latter may be replaced by a shape memory element which acts according to the temperature, for example a shape memory spring, wherein, more generally, such a shape memory element and the thermostatic element 30 associated with the return spring 34 are simply possible embodiments for a thermostatic actuator which provides the function of movement of the slide 20 inside the chamber 10.3 as a function of the temperature and a dedicated part, such as the piston 32, wherein the thermostatic element 30, defines, by its axial position, the set temperature at which the slide regulates the temperature of the mixture.

1.-11. (canceled)

12. A thermostatic cartridge for regulating cold and hot fluids to be mixed, wherein the thermostatic cartridge comprises:
a base, which defines an axis and which comprises two separate base parts that are designed to be assembled to one another in an assembled state of the thermostatic cartridge, wherein in an assembled state of the first and second base parts, the two base parts are superimposed axially against each other, with the interposition of a seal, and together delimit a chamber for mixing cold and hot fluids, wherein the chamber is sealed by the seal while being connected to the outside of the base both by a first inlet for the cold fluid and a second inlet for the hot fluid which are delimited by one of the two base parts, and by an outlet for a mixture of the cold and hot fluids, which is delimited by the other of the two base parts,
a slide, which is displaceable substantially parallel to the axis inside the chamber in order to inversely vary the respective flow sections of a first passage, which is supplied by the first inlet and which is delimited axially between the slide and one of the two base parts, and a second passage, which is supplied by the second inlet and which is delimited axially between the slide and the other of the two base parts,
a thermostatic actuator, which is at least partially arranged in the chamber and which is connected to the slide and the base in order, as a function of the temperature of the mixture, to move the slide inside the chamber to a regulation position corresponding to a set temperature that is defined by the axial position that has a dedicated part of the thermostatic actuator,
a cover which, in the assembled state of the thermostatic cartridge, is secured to the base, and
a regulation and control system, which is at least partially movably mounted in the cover so as, in the assembled state of the thermostatic cartridge, both to vary the flow rate of the cold fluid supplied to the first inlet and the flow rate of the hot fluid supplied to the second inlet, and to regulate the flow and temperature of the mixture in the outlet,
wherein a first of the two base parts comprises at least one tab:
which extends substantially parallel to the axis,
which, at a first end of its two axial ends, is connected to the rest of the first base part both fixedly along the axis and deformably to allow an elastic deflection of the at least one tab transversely to the axis,
which, at its second axial end, is provided with at least one retaining surface against which the second base part bears axially in order to hold the first and second base parts assembled, and
which, at its second axial end, is also provided with a protruding relief which is designed to interact with the cover, so that, during assembly of the cover and the base, the cover and the protruding relief slide against one another to deflect the tab towards the axis and, in the assembled state of the thermostatic cartridge, the protruding relief engages a hole of the cover to axially retain the cover relative to the base.

13. The thermostatic cartridge according to claim 12, wherein the at least one tab extends from a peripheral portion of the first base part and interacts with a peripheral portion of the second base part so that, during assembly of the first and second base parts, the peripheral portion of the second base part and the at least one tab slide against each other in order to deflect the at least one tab in opposite direction to the axis and, in the assembled state of the first and second base parts, the at least one retaining surface engages the peripheral portion of the second base part in order to axially retain the first base part relative to the second base part.

14. The thermostatic cartridge according to claim 12, wherein the at least one retaining surface of the at least one tab protrudes from a side edge of the at least one tab.

15. The thermostatic cartridge according to claim 14, wherein the at least one retaining surface of the at least one tab protrudes from a side edge of the at least one tab in a direction that is orthoradial to the axis.

16. The thermostatic cartridge according to claim 14, wherein the at least one tab is provided with two retaining surfaces, which extend on either side of the at least one tab, respectively from either of the side edges of the at least one tab.

17. The thermostatic cartridge according to claim 12, wherein the first base part is provided with at least two tabs, which are distributed around the axis.

18. The thermostatic cartridge according to claim 17, wherein the first base part is provided with two tabs. which are diametrically opposite relative to the axis and which have respective widths that are different from each other.

19. The thermostatic cartridge according to claim 12, wherein the second base part comprises, for the at least one tab, a housing, which is designed to receive the at least one tab in the assembled state of the first and second base parts, and within which the second base part defines, for the at least one retaining surface, a bearing surface against which the at least one retaining surface abuts axially to hold the first and second base parts assembled.

20. The thermostatic cartridge according to claim 12, wherein the thermostatic actuator comprises:
a thermostat, which comprises a body, containing a thermally-expandable material, and a piston that is displaceable in translation substantially along the axis relative to the body under the effect of expansion of the thermally-expandable material, wherein the piston forms said dedicated part of the thermostatic actuator, and wherein the body is connected to the slide to move the slide in substantially axis-wise translation within the chamber, and
a return spring which is axially interposed between the body of the thermostat and one of the first and second base parts in order to return the body and the piston to one another during contraction of the thermally-expandable material.

21. The thermostatic cartridge according to claim 12, wherein the base, the slide and the thermostatic actuator together form, in the assembled state of the first and second base parts, a demountable preassembled module.

22. The thermostatic cartridge according to claim 12, wherein the cover and the protruding relief are provided to slide against one another in order to deflect the at least one tab towards the axis during an axial connection between the base and the cover.
